(19) United States
(12) Patent Application Publication
(10) Pub. No.: US 2026/0150040 A1
(43) Pub. Date: May 28, 2026

(54) RADIO ACCESS NODE SHUTDOWN ORCHESTRATION

(71) Applicant: T-Mobile USA, Inc., Bellevue, WA (US)

(72) Inventors: Jacob Andrew Fontana, Bellevue, WA (US); Rafal Lazarczyk, Mission, KS (US); Jennifer Feria Reyes, Bothell, WA (US); Sharath Somashekar, Overland Park, KS (US)

(21) Appl. No.: 18/956,503

(22) Filed: Nov. 22, 2024

(51) Int. Cl. H04W 52/02; H04W 24/02; H04W 48/16

(52) U.S. Cl. CPC H04W 52/0206; H04W 24/02; H04W 48/16

(57) ABSTRACT

Methods, devices, and systems related to shutdown order in dynamic power adjustment are disclosed. In one example aspect, a method for wireless communication includes receiving information about a plurality of access nodes indicating locations of the plurality of access nodes and types of the plurality of access nodes, monitoring multiple data sets of the plurality of access nodes, establishing a logical map of the plurality of access nodes, determining a classification of the plurality of access nodes; and determining an order of shutting down the plurality of access nodes based on the logical map and the classification of the plurality of access nodes using one or more machine learning models.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency, are also important to meeting the needs of various communication scenarios.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates Fifth Generation (5G) core network functions (NFs) that can implement aspects of the present technology.

FIG. 3 illustrates an example of inappropriate shut down in a case of emergency.

FIG. 4 illustrates example operations for shutdown orchestration in accordance with one or more embodiments of the present technology.

FIG. 5 illustrates an example Artificial Intelligent (AI)/Machine Learning (ML) system in accordance with one or more embodiments of the present technology.

FIG. 6 is a flowchart representation of a method for wireless communication in accordance with one or more embodiments of the present technology.

FIG. 7 shows an example logical map corresponding to the distribution of base stations shown in FIG. 3 in accordance with one or more embodiments of the present technology.

FIG. 8 is a flowchart representation of a method for wireless communication in accordance with one or more embodiments of the present technology.

FIG. 9 shows an example logical map corresponding to the core network nodes shown in FIG. 2 in accordance with one or more embodiments of the present technology.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Energy-aware networking involves strategies and technologies designed to reduce the energy consumption of network infrastructure. Effective monitoring and management tools are necessary to dynamically adjust power usage and ensure that energy-saving measures are optimized without compromising network performance. This patent document discloses techniques that can be implemented in various embodiments to select network elements to shut down in an appropriate shutdown order, based on information of the network elements such as power, location, carrier, and/or connections, and further leverages machine learning techniques to achieve the desired power goal while maintaining a certain service level to users. The disclosed techniques can be applied to various types of network elements, including radio access nodes and core network nodes.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

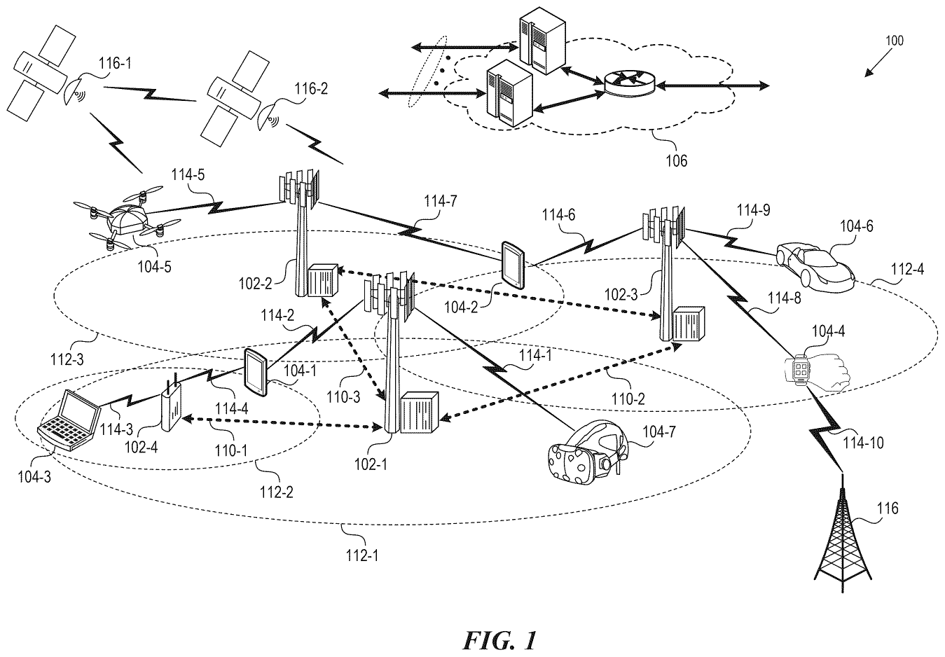

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

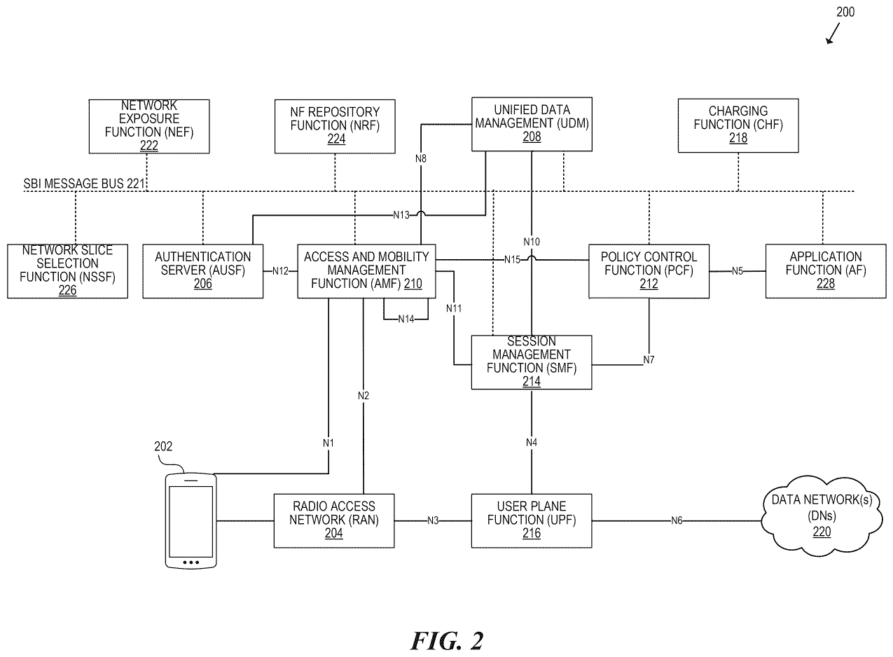

FIG. 2 is a block diagram that illustrates an architecture 200 including 5G core NFs that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Shutdown Orchestration

Energy-aware networking involves strategies and technologies designed to reduce the energy consumption of network infrastructure. This is increasingly important due to the growing energy demands of data centers, telecommunications networks, and other IT infrastructure. Dynamic power management involves adjusting the power usage of network elements based on current demand. This can include turning off components (e.g., shutting down routers, switches, or servers that are not in use) and/or scaling down performance (e.g., reducing the performance of network elements during low traffic periods to save energy). Lower energy consumption directly translates to reduced electricity bills, which is a significant cost factor for large-scale network operations. Reducing energy usage helps in lowering the carbon footprint of network operations, contributing to environmental sustainability. By reducing the operational time of network elements, their lifespan can be extended, leading to lower replacement costs and reduced electronic waste. Furthermore, dynamic power management is important for situations such as planned or unplanned outages, emergencies where there is a load shedding required, natural disasters, or when there is a need to bring down energy consumption to prevent circuit breaks.

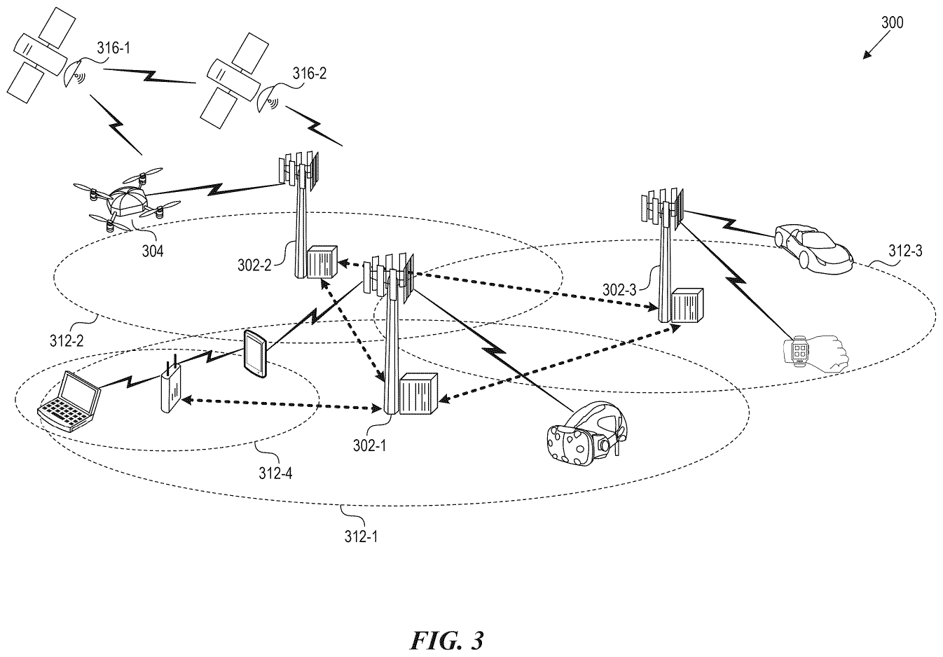

Implementing energy-saving strategies can be complex and requires significant changes to network management practices and infrastructure. Effective monitoring and management tools are necessary to dynamically adjust power usage and ensure that energy-saving measures are optimized without compromising network performance. Currently, when components need to be turned off for energy saving or in response to emergency scenarios, components having the highest amperage usage are turned off in a randomized order and in a short period of time, without considering end user priorities or requirements. FIG. 3 illustrates an example of inappropriate shut down 300 in a case of emergency. In this example coverage areas 312-1, 312-3, and 312-4 provided by base stations 302-1 and 302-3 are for residential/commercial uses, while coverage area 312-2 provided by the base station 302-2 is configured to mostly support emergency services. To support the operation of satellites 316-1, 316-2 and emergency drone 304, the amperage usage of the base station 302-2 remains high. When network nodes need to be shut down for energy saving, e.g., due to natural catastrophes, the base station 302-2 may be erroneously shut down, impacting emergency responses, thereby leading to undesired chaos.

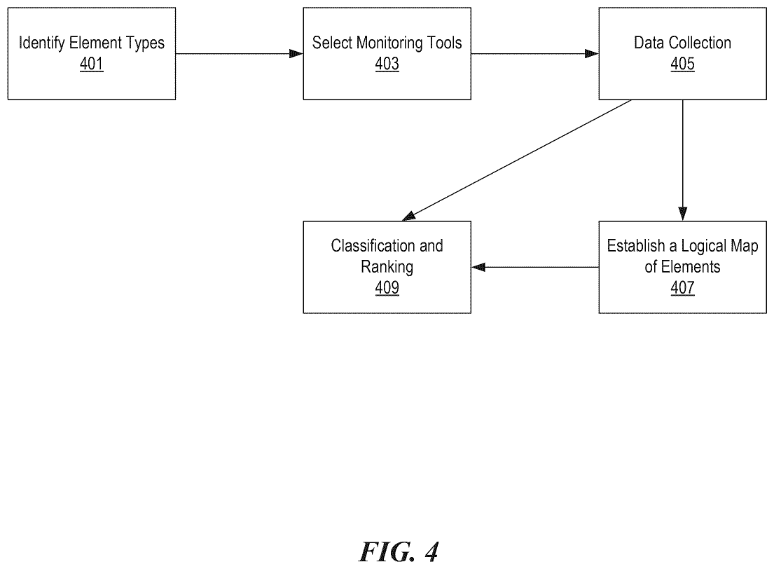

This patent document discloses techniques that can be implemented in various embodiments to select network elements to shut down in an appropriate shutdown order to achieve the desired power goal while maintaining a certain service level to users. FIG. 4 illustrates example operations for shutdown orchestration in accordance with one or more embodiments of the present technology.

At Operation 401, information about network elements can be collected, such as device locations and specifications. For example, information about network element types (e.g., routers, switches, servers, access points) can be collected as a device information inventory. As another example, deployment information, such as redundant deployment of network elements (e.g., core network nodes) to increase network reliability, can be provided for subsequent operations.

At Operation 403, monitoring tools for the network elements are selected. In some embodiments, power meters or smart plugs can be used to measure the power consumption of individual elements. In some embodiments, built-in monitoring capabilities of network elements can be accessed via corresponding interfaces to collect data at Operation 405.

At Operation 405, data about the network elements is collected at appropriate intervals and stored in a database or a centralized monitoring system for further processing. Example types of data include at least the following:
1. Power data: power readings, such as watts/hr or current draw at the element and sub-component level.
2. Utilization data: number of user devices connected to the network element, amount of Physical Resource Blocks (PRBs) used, amount of traffic volume, number of carriers, and/or Central Processing Unit (CPU) utilization rate.
3. Connection data: a small set of data packets can be sampled (e.g., examining source and destination addresses) to determine the connection and routing conditions between network nodes. The connection data can help determine the connection relationships among the network elements, particularly in the core network.
4. Carrier component data: information indicating the number of carriers and/or carrier components (CCs) provided by the network elements can be collected. For example, in the case of access nodes, information about the access node carrier capabilities (e.g., how many carriers and/or CCs each access node can support) is collected.

At Operation 407, a logical map of network elements can be established, e.g., based at least partly on the collected connection data. The logical map can correspond to the connections between network elements. In some embodiments, static deployment information can also be provided to enhance the details of the logical map.

At Operation 409, the network elements can be classified and ranked according to determine a shutdown order suitable for the network elements.

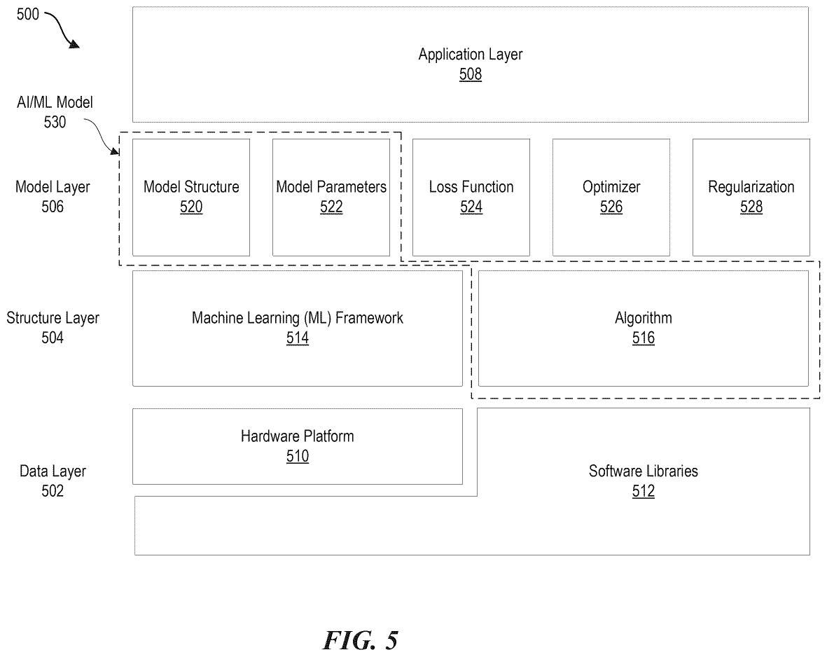

FIG. 5 illustrates an example Artificial Intelligent (AI)/Machine Learning (ML) system in accordance with one or more embodiments of the present technology. The AI/ML system can be implemented to perform operations such as 407 and 409 shown in FIG. 4. As shown in FIG. 5, the AI/ML system 500 can include a set of layers, which conceptually organize elements within an example network topology for the AI system's architecture to implement a particular AI/ML model 530. Generally, an AI/ML model 530 is a computer-executable program implemented by the AI/ML system 500 that analyzes data to make predictions. Information can pass through each layer of the AI/ML system 500 to generate outputs for the AI/ML model 530. The layers can include a data layer 502, a structure layer 504, a model layer 506, and an application layer 508. An algorithm 516 of the structure layer 504 and a model structure 520 and model parameters 522 of the model layer 506 together form the example AI/ML model 530. A loss function engine 524, an optimizer 526, and a regularization engine 528 work to refine and optimize the AI/ML model 530, and the data layer 502 provides resources and support for application of the AI/ML model 530 by the application layer 508.

The data layer 502 acts as the foundation of the AI/ML system 500 by preparing data for the AI/ML model 530 (e.g., data from Operation 405 in FIG. 4). As shown, the data layer 502 can include two sub-layers: a hardware platform 510 and one or more software libraries 512. The hardware platform 510 can be designed to perform operations for the AI/ML model 530 and include computing resources for storage, memory, logic, and networking. The hardware platform 510 can process amounts of data using one or more servers. The servers can perform backend operations such as parallel calculations, training, and the like. Examples of servers used by the hardware platform 510 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 510 can include Infrastructure as a Service (IaaS) resources, which are computing resources (e.g., servers, memory, etc.) offered by a cloud services provider. The hardware platform 510 can also include computer memory for storing data about the AI/ML model 530, application of the AI/ML model 530, and training data for the AI/ML model 530. The computer memory can be a form of random-access memory (RAM), such as dynamic RAM, static RAM, and non-volatile RAM.

The software libraries 512 can be thought of as suites of data and programming code, including executables, used to control the computing resources of the hardware platform 510. The programming code can include low-level primitives (e.g., fundamental language elements) that form the foundation of one or more low-level programming languages, such that servers of the hardware platform 510 can use the low-level primitives to carry out specific operations. The low-level programming languages do not require much, if any, abstraction from a computing resource's instruction set architecture, allowing them to run quickly with a small memory footprint. Examples of software libraries 512 that can be included in the AI/ML system 500 include Intel Math Kernel Library, Nvidia cuDNN, Eigen, and Open BLAS.

The structure layer 504 can include an AI/ML framework 514 and the algorithm 516. The AI/ML framework 514 can be thought of as an interface, library, or tool that allows network carriers to build and deploy the AI/ML model 530 (e.g., Operation 407 in FIG. 4). The AI/ML framework 514 can include an open-source library, an application programming interface (API), a gradient-boosting library, an ensemble method, and/or a deep learning toolkit that work with the layers of the AI/ML system 500 to facilitate development of the AI/ML model 530. For example, the AI/ML framework 514 can distribute processes for application or training of the AI/ML model 530 across multiple resources in the hardware platform 510. The AI/ML framework 514 can also include a set of pre-built components that have the functionality to implement and train the AI/ML model 530 and allow network carriers to use pre-built functions and classes to construct and train the AI/ML model 530. Thus, the AI/ML framework 514 can be used to facilitate data engineering, development, hyperparameter tuning, testing, and training for the AI/ML model 530. Examples of AI/ML frameworks 514 that can be used in the AI/ML system 500 include TensorFlow, PyTorch, Scikit-Learn, Keras, Cafffe, LightGBM, Random Forest, and Amazon Web Services.

The algorithm 516 can be an organized set of computer-executable operations used to generate output data from a set of input data and can be described using pseudocode. The algorithm 516 can include complex code that allows the computing resources to learn from new input data and create new/modified outputs based on what was learned. In some implementations, the algorithm 516 can build the AI/ML model 530 through being trained while running computing resources of the hardware platform 510. This training allows the algorithm 516 to make predictions or decisions without being explicitly programmed to do so. For example, the algorithm 516 can predict the logical relations between the network elements and/or the classification of the network elements. Once trained, the algorithm 516 can run at the computing resources as part of the AI/ML model 530 to make predictions or decisions, improve computing resource performance, or perform tasks. The algorithm 516 can be trained using supervised learning, unsupervised learning, semi-supervised learning, and/or reinforcement learning.

Using supervised learning, the algorithm 516 can be trained to learn patterns (e.g., map input data to output data) based on labeled training data. For instance, data collected from core network and/or radio access nodes is preprocessed to form a set of training data. The network carrier may label the training data based on the data and train the AI/ML model 530 by inputting the training data to the algorithm 516. In some instances, as mentioned above, the training data is converted to a set of features or feature vectors for input to the algorithm 516. Once trained, the algorithm 516 can be validated on new data to determine whether the algorithm 516 is predicting accurate labels for the new data.

Supervised learning can involve classification and/or regression. Classification techniques involve teaching the algorithm 516 to identify a category of new observations based on training data and are used when input data for the algorithm 516 is discrete. Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification. Under unsupervised learning, the algorithm 516 learns patterns from unlabeled training data. In particular, the algorithm 516 is trained to learn hidden patterns and insights of input data, which can be used for data exploration or for generating new data. Said another way, unsupervised learning is used to train the algorithm 516 to find an underlying structure of a set of data, group the data according to similarities, and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has fewer or no similarities to another group. Examples of clustering techniques include density-based methods, hierarchical-based methods, partitioning methods, and grid-based methods. In one example, the algorithm 516 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 516 may be trained to be an Isolation Forest, local outlier factor (LOF) algorithm, or k-NN algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 516 include factor analysis, item response theory, latent profile analysis, and latent class analysis.

The model layer 506 implements the AI/ML model 530 using data from the data layer 502 and the algorithm 516 and AI/ML framework 514 from the structure layer 504, thus enabling decision-making capabilities of the AI/ML system 500. The model layer 506 includes the model structure 520, model parameters 522, the loss function engine 524, the optimizer 526, and the regularization engine 528.

The model structure 520 describes the architecture of the AI/ML model 530 of the AI/ML system 500. The model structure 520 defines the complexity of the pattern/relationship that the AI model 530 expresses. Examples of structures that can be used as the model structure 520 include decision trees, support vector machines, regression analyses, Bayesian networks, Gaussian processes, genetic algorithms, and artificial neural networks (or, simply, neural networks). The model structure 520 can include a number of structure layers, a number of nodes (or neurons) at each structure layer, and activation functions of each node. Each node's activation function defines how the node converts data received to data output. The structure layers may include an input layer of nodes that receive input data and an output layer of nodes that produce output data. The model structure 520 may include one or more hidden layers of nodes between the input and output layers. The model structure 520 can be a neural network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 522 represent the relationships learned during training and can be used to make predictions and decisions based on input data. The model parameters 522 can weight and bias the nodes and connections of the model structure 520. For instance, when the model structure 520 is a neural network, the model parameters 522 can weight and bias the nodes in each layer of the neural networks, such that the weights determine the strength of the nodes and the biases determine the thresholds for the activation functions of each node. The model parameters 522, in conjunction with the activation functions of the nodes, determine how input data is transformed into desired outputs. The model parameters 522 can be determined and/or altered during training of the algorithm 516.

The loss function engine 524 can determine a loss function, which is a metric used to evaluate the performance of the AI/ML model 530 during training. For instance, the loss function engine 524 can measure the difference between a predicted output of the AI/ML model 530 and the actual output of the AI/ML model 530 and is used to guide optimization of the AI/ML model 530 during training to minimize the loss function. The loss function may be presented via the AI/ML framework 514, such that a network carrier can determine whether to retrain or otherwise alter the algorithm 516 if the loss function is over a threshold. In some instances, the algorithm 516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 526 adjusts the model parameters 522 to minimize the loss function during training of the algorithm 516. In other words, the optimizer 526 uses the loss function generated by the loss function engine 524 as a guide to determine what model parameters lead to the most accurate AI/ML model 530. Examples of optimizers include Gradient Descent (GD), Adaptive Gradient Algorithm (AdaGrad), Adaptive Moment Estimation (Adam), Root Mean Square Propagation (RMSprop), Radial Base Function (RBF), and Limited-memory BFGS (L-BFGS). The type of optimizer 526 used may be determined based on the type of model structure 520 and the size of data and the computing resources available in the data layer 502.

The regularization engine 528 executes regularization operations. Regularization is a technique that prevents over-and underfitting of the AI/ML model 530. Overfitting occurs when the algorithm 516 is overly complex and too adapted to the training data, which can result in poor performance of the AI/ML model 530. Underfitting occurs when the algorithm 516 is unable to recognize even basic patterns from the training data such that it cannot perform well on training data or on validation data. The regularization engine 528 can apply one or more regularization techniques to fit the algorithm 516 to the training data properly, which helps constrain the resulting AI/ML model 530 and improves its ability for generalized application. Examples of regularization techniques include lasso (L1) regularization, ridge (L2) regularization, and elastic (L1 and L2) regularization.

### Shutdown of Radio Access Nodes (RANs)

As shown in FIG. 2, core network elements are interconnected. Shutting off a core network node that does not have redundancy deployment often impacts many other core network elements. Shutting down individual RAN elements brings less impact to the network to achieve the desired power consumption or testing goals.

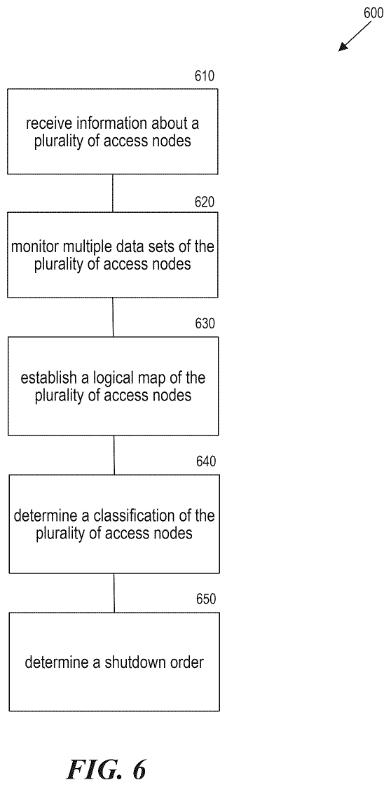

To ensure proper shutdown of the RAN elements, the RAN elements can be classified and ranked to determine a shut-down order. FIG. 6 is a flowchart representation of a method for wireless communication in accordance with one or more embodiments of the present technology. The method 600 includes receiving, at operation 610, by a network node in a core network, information about a plurality of access nodes indicating locations of the plurality of access nodes and types of the plurality of access nodes (e.g., macro cell, micro cell, etc.). The method 600 includes, at operation 620, monitoring, by the network node, multiple data sets of the plurality of access nodes. The multiple data sets comprise a first set of power data of the plurality of access nodes, a second set of utilization data of the plurality of access nodes, and a third set of carrier data of the plurality of access nodes. The method 600 includes, at operation 630, establishing, by the network node, a logical map of the plurality of access nodes based on at least the locations of the plurality of access nodes. The method 600 includes, at operation 640, determining, by the network node, a classification of the plurality of access nodes based on the types of the plurality of access nodes, the multiple data sets of the plurality of access nodes, and the logical map of the plurality of access nodes using one or more machine learning models. The one or more machine learning models are trained based on historical data sets of the plurality of access nodes. The method 600 also includes, at operation 650, determining, by the network node, an order of shutting down the plurality of access nodes based on the logical map and the classification of the plurality of access nodes.

In some embodiments, the order can be determined by the one or more machine learning models trained based on the following considerations using power data, utilization data, and carrier data.

### 1. Power Data

In some embodiments, power consumption data can be ranked to determine the shutdown order of the access nodes. In some embodiments, the power consumption can be further ranked according to the access node type(s). A macro cell can be ranked higher than a micro cell having the same power consumption rate as shutting down the macro cell can result in more power savings.

### 2. Utilization Data

Utilization data includes the utilization rate of the processors at the access nodes and/or the utilization rate of the nodes themselves (e.g., how many user devices are connected to each node). Utilization data also includes bandwidth utilization rates and/or time-frequency resource utilization rates of the access nodes (e.g., central processing unit utilization, the amount of physical resource blocks used by an access node, traffic volume handled by an access node, etc.).

### 3. Carrier Data

Carrier data includes the number of radio carriers and/or component carriers that each access node can support. In some embodiments, different radio access technologies (RATs) are supported by an access node. Carrier usage can be ranked according to respective RATs (e.g., legacy 3G usage is ranked higher for shutdown). In some embodiments, carrier usage can be ranked according to cells or radio frequencies associated with the access nodes. Based on volume of downlink or uplink traffic volume, average physical resource blocks utilized over a fixed time, and/or number of RRC connections connected to each radio frequency, the highest utilized radio frequency can be designated as the dominant radio frequency for that access node.

In some embodiments, carrier usage can be categorized according to whether the usage is for a primary cell (PCell) or a secondary cell (SCell) connection. SCell connections are ranked higher and given higher priority in the shutdown process.

In some embodiments, the carrier data also includes information indicating the service types provided by the access nodes. For example, the carrier data can indicate that a first set of component carriers correspond to a network slice for multimedia services and a second set of component carriers correspond to a network slice dedicated for emergency/first responder calls.

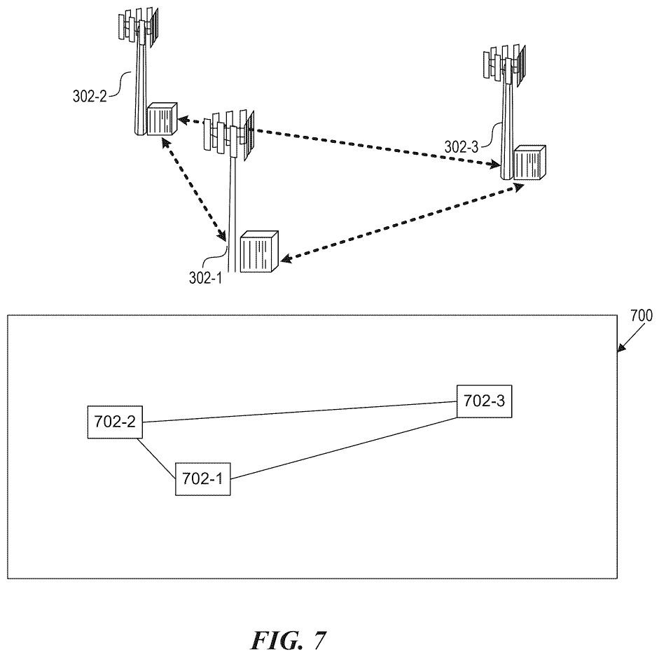

In some embodiments, the logical map can be established based on the locations of the access nodes. When an area is covered by a dense distribution of access nodes, a subset of access nodes can be shut down to reach the power target while maintaining a certain level of service to the users. FIG. 7 shows an example logical map corresponding to the distribution of base stations shown in FIG. 3 in accordance with one or more embodiments of the present technology. Base stations 302-1, 302-2, and 302-3 are modeled as 702-1, 702-2, and 702-3 in the logical map 700 based on the locational information.

As discussed above, one or more machine learning models can be trained based on historical data to determine the classification of access nodes. In some embodiments, the access nodes can be grouped based on past trends of utilization of each RAN node (e.g., one month of data). For example, a list of minimally used nodes can be determined. The list can be further reduced based on additional past utilization data (e.g., two months or six months of data). In some embodiments, the one or more machine learning models include at least one classification model to classify the access nodes, e.g., based on the node types, locations, and carrier data. For example, the one or more machine learning models can correlate the list of nodes determined based on historical data with carrier data (e.g., carrier usage according to RATs or connection types) to determine the shutdown order. In some embodiments, instead of shutting down the entire access node, selected carriers can be shut down, when applicable, based on carrier data.

In some embodiments, the base stations are classified based on information such as the types of the base stations (e.g., micro/macro, emergency/regular). For example, referring back to FIG. 3 and FIG. 7, base station 302-2 is classified as an emergency base station because a large portion of services that it supports are emergency services. Based on the classification and the logical map corresponding to the base stations, base station 302-1 is thus ranked high in the shutdown order (that is, base station 302-1 can be shutdown first) due to its proximity to an emergency base station 302-2 that is kept on even when power usage adjustment is needed.

In some embodiments, the shutdown process can be performed iteratively. For example, after an initial shutdown order is determined, a few nodes are shut down first. The power utilization is measured after the shutdown to determine if the power target is met. If not, the shutdown process is repeated until the target is achieved. When power can be restored, the shutdown process can be reversed to restore power to access nodes.

### Shutdown of Core Network Nodes

In some cases, shutting down a selected number of access nodes may not be sufficient to achieve the power target and additional core network nodes need to be shut down to achieve the power target.

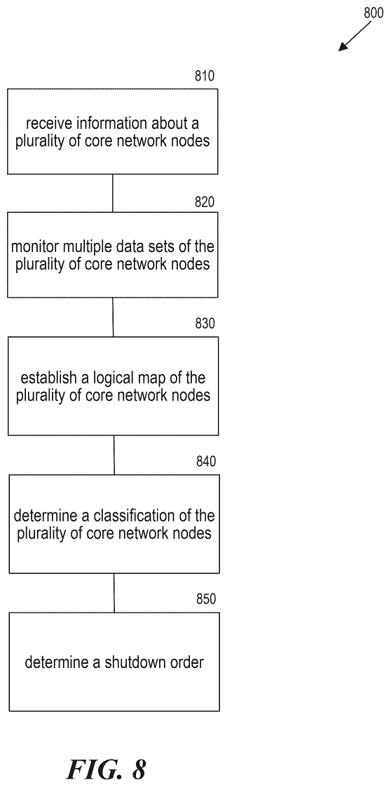

FIG. 8 is a flowchart representation of a method for wireless communication in accordance with one or more embodiments of the present technology. The method 800 includes, at operation 810, receiving information about a plurality of core network nodes indicating locations of the plurality of core network nodes and types of the plurality of core network nodes. The information indicates at least a redundant deployment of at least one core network node. The method 800, at operation 820, monitors multiple data sets of the plurality of core network nodes. The multiple sets of data comprise a first set of power data of the plurality of core network nodes, a second set of utilization data of the plurality of core network nodes, and a third set of connection data of the plurality of core network nodes. The method 800, at operation 830, establishes a logical map of the plurality of core network nodes based at least on the information and the third set of connection data of the plurality of core network nodes using one or more machine learning models. The one or more machine learning models are trained based on historical data sets of the plurality of core network nodes. The method 800, at operation 840, determines a classification of the plurality of core network nodes based on the multiple data sets of the plurality of access nodes and the logical map of the plurality of access nodes using the one or more machine learning models. The method 800, at operation 850, determines an order of shutting down the plurality of core network nodes based on the logical map and the classification of the plurality of access nodes.

In some embodiments, the order can be determined by the one or more machine learning models trained based on the following considerations using power data, utilization data, and connection data.

### 1. Power Data

In some embodiments, power consumption data can be ranked to determine the shutdown order of the core network nodes. In some embodiments, the power consumption can be further ranked according to the core network node types (e.g., as shown in FIG. 2).

### 2. Utilization Data

Utilization data includes the utilization rate of the processors at the core network nodes and/or the utilization rate of the nodes themselves (e.g., how many connections the node provides, central processing unit utilization, bandwidth utilization/traffic volume handled by a core network node, etc.). In some embodiments, utilization information from network nodes such as Operations Support System (OSS) or Element Management System (EMS), such as number of users connected, the amount of traffic volume (voice, messages, data), the type of traffic, and or CPU utilization can be use to determine utilization for each node.

### 3. Connection Data

Connection data (e.g., information about data packets in radio data bearers or network sessions) indicates the status of the connections among the core network nodes.

In some embodiments, a logical map can be established based on information about the location and/or the deployment of the core network nodes and the connection data. For example, connection data such as end-to-end call flows is captured for the analysis of the core network topology and construction of the logical map. In the case of redundant deployment, connection data can help determine which nodes are the primary nodes used for network activities and which nodes serve as backup redundant nodes to increase reliability. When power adjustment is needed, backup redundant nodes can be ordered prior to the nodes that are actively in use. In some embodiments, multiple network functions are deployed in a single server, sharing the same physical processor(s) and/or computing components. The multiple network functions can have different utilization rates—some of the may be highly utilized or even dominantly used, while the remaining have a lower utilization rate. The shutdown determination can ensure the dominant network function remains alive and other network functions are shut down, without shutting down the server completely.

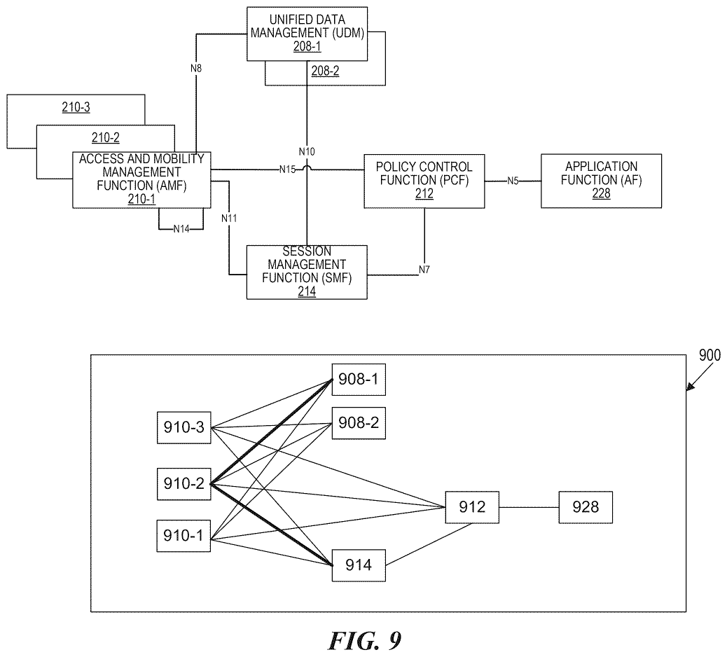

FIG. 9 shows an example logical map corresponding to the core network nodes shown in FIG. 2 in accordance with one or more embodiments of the present technology. Redundant deployment is adopted for AMF (210-1, 210-2, 210-3) and UDM (208-1, 208-2). The redundant AMF nodes are modeled as 910-1, 910-2, 910-3 and the redundant UDM 908-1, 908-2 in the logical map 900. The SMF node 214 is modeled as 914, the PCF 212 is modeled as 912, and the AF 228 is modeled as 928 in the logical map based on the deployment information. In addition to the deployment information, connection data can be used to indicate the actual connection status. For example, the connection data suggests that AMF 910-2 and UDM 908-1 are the primary nodes, where AMF 910-1, 910-2 and UDM 908-2 are backup modes.

As discussed above, one or more machine learning models can be trained based on historical data to determine the classification of core network nodes. In some embodiments, the core network nodes can be grouped based on past trends of utilization of each core network node (e.g., one month of data). For example, a list of minimally used nodes can be determined (e.g., such as backup nodes in redundant deployment). The list can be further reduced based on additional past utilization data (e.g., two months or six months of data). In some embodiments, an exception list of essential elements can be created based on node types. For example, elements that do not have a redundancy option or elements that are considered as stable/special elements can be added to the exception list.

In some embodiments, the one or more machine learning models include at least one classification model to classify the core network nodes, e.g., based on the node types, locations, and connection data. In some embodiments, the base stations are classified based on information such as the types of the base stations (e.g., AMF/AF/PCF). For example, referring back to FIG. 2 and FIG. 9, AMF 910-2 and UDM 208-1 are grouped or classified as primary nodes while AMF 910-1, 910-3 and UDM 908-2 are grouped or classified as backup nodes. Based on the classification and the logical map corresponding to the core network nodes, AMF 910-1, 910-3 and UDM 908-2 are ranked high in the shutdown order (that is, AMF 910-1, 910-3 and UDM 908-2 can be shutdown first) due to their redundant nature and the amount of connection/traffic that they support.

In some embodiments, an exception list of essential elements can be created based on node types. For example, elements that do not have a redundancy option or elements that are considered as stable/special elements can be added to the exception list. In some embodiments, the shutdown process can be performed iteratively. For example, after an initial shutdown order is determined, a few nodes are shut down first. The power utilization is measured after the shutdown to determine if the power target is met. If not, the shutdown process is repeated until the target is achieved. When power can be restored, the shutdown process can be reversed to restore power to core network nodes.

In some embodiments, the one or more machine learning models can take into account of the node classification, the dominant/highly-utilized network functions, and/or physical subcomponents in the shutdown evaluation, the historical node ranking, correlating with the ‘exclusion node list’ to short list those core elements/network functions that can be shutdown. Additionally, the one or more machine learning models can determine the least of minimum network functions that are required to make an end-to-end call based on the network topology, in addition to the above available information. The one or more machine learning models can automatically trigger commands to “power relays” to shutdown respective core elements functions, and entire core nodes where applicable. In addition, the one or more machine learning models can instruct the physical server with multiple virtual functions/network functions to kill any unnecessary core functions in order to save power. The one or more machine learning models can measure new power utilization and checks if the target is met. If not, the process defined above can be repeated until targets are met. Once a command is issued to restore power, system works in reverse to automatically restore power.

### Computer System

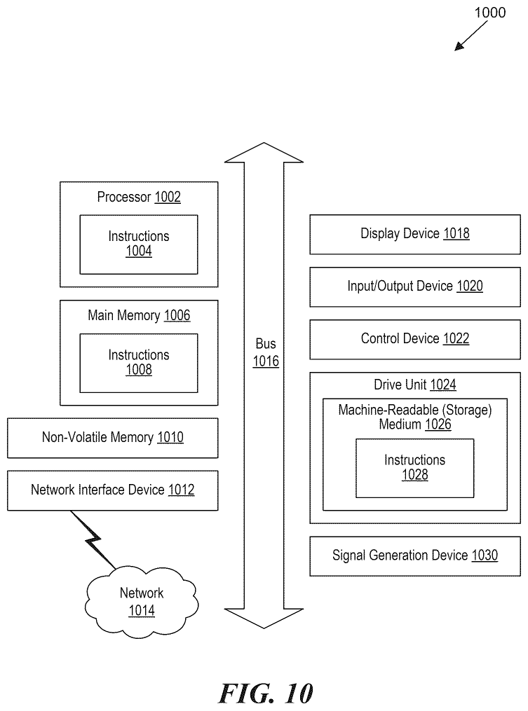

FIG. 10 is a block diagram that illustrates an example of a computer system 1000 in which at least some operations described herein can be implemented. As shown, the computer system 1000 can include: one or more processors 1002, main memory 1006, non-volatile memory 1010, a network interface device 1012, a video display device 1018, an input/output device 1020, a control device 1022 (e.g., keyboard and pointing device), a drive unit 1024 that includes a machine-readable (storage) medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real time, in near real time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Example Solutions

Example solutions related to shutdown of access nodes are described below.
1. A method for wireless communication, comprising: receiving, by a network node in a core network, information about a plurality of access nodes indicating locations of the plurality of access nodes and types of the plurality of access nodes; monitoring, by the network node, multiple data sets of the plurality of access nodes, wherein the multiple data sets comprise a first set of power data of the plurality of access nodes, a second set of utilization data of the plurality of access nodes, and a third set of carrier data of the plurality of access nodes; establishing, by the network node, a logical map of the plurality of access nodes based on at last the locations of the plurality of access nodes; determining, by the network node, a classification of the plurality of access nodes based on the types of the plurality of access nodes, the multiple data sets of the plurality of access nodes, and the logical map of the plurality of access nodes using one or more machine learning models, wherein the one or more machine learning models are trained based on historical data sets of the plurality of access nodes; and determining, by the network node, an order of shutting down the plurality of access nodes based on the logical map and the classification of the plurality of access nodes using the one or more machine learning models.
2. The method of solution 1, wherein the types of the plurality of access nodes comprise at least a macro cell type or micro cell type.
3. The method of solution 1, wherein the first set of power data comprises power consumption data of the plurality of access nodes, and wherein the second set of utilization data comprises at least one of: a central processing unit utilization rate of each access node or a time-frequency resource utilization rate of each access node.
4. The method of solution 1, wherein the third set of carrier data comprises at least usage information for component carriers, usage information for connection types, or usage information for service types.
5. The method of solution 1, wherein the classification comprises grouping of the plurality of access nodes based on the first set of power data and the second set of utilization data.
6. The method of solution 1, wherein the order indicates a partial shutdown of selected carriers of an access node based on the third set of carrier data.
7. The method of solution 1, wherein the order is determined iteratively until a power consumption target for the plurality of access nodes is achieved.
8. A device for wireless communication in communication with one or more machine learning models, the device comprising at least one processor that is configured to cause the device to: receive information about a plurality of access nodes indicating locations of the plurality of access nodes and types of the plurality of access nodes; monitor multiple data sets of the plurality of access nodes, wherein the multiple data sets comprise a first set of power data of the plurality of access nodes, a second set of utilization data of the plurality of access nodes, and a third set of carrier data of the plurality of access nodes; establish a logical map of the plurality of access nodes based at least on the locations of the plurality of access nodes; determine a classification of the plurality of access nodes based on the multiple data sets of the plurality of access nodes and the logical map of the plurality of access nodes using the one or more machine learning models, wherein the one or more machine learning models are trained based on historical data sets of the plurality of access nodes; and determine an order of shutting down the plurality of access nodes based on the logical map and the classification of the plurality of access nodes using the one or more machine learning models.
9. The device of solution 8, wherein the types of the plurality of access nodes comprise at least a macro cell type or micro cell type.
10. The device of solution 8, wherein the first set of power data comprises power consumption data of the plurality of access nodes, and wherein the second set of utilization data comprises at least one of: a central processing unit utilization rate of each access node or a time-frequency resource utilization rate of each access node.
11. The device of solution 8, wherein the third set of carrier data comprises at least usage information for component carriers, usage information for connection types, or usage information for service types.
12. The device for solution 8, wherein the classification comprises grouping of the plurality of access nodes based on the first set of power data and the second set of utilization data.
13. The device of solution 8, wherein the order indicates a partial shutdown of selected carriers of an access node based on the third set of carrier data.
14. The device of solution 8, wherein the order is determined iteratively until a power consumption target for the plurality of access nodes is achieved.
15. A non-transitory, computer-readable storage medium comprising instructions recorded thereon, wherein the instructions, when executed by at least one data processor of a system, cause the system to: receive multiple data sets associated with a plurality of access nodes, wherein the multiple data sets comprise a first set of power data of the plurality of access nodes, a second set of utilization data of the plurality of access nodes, and a third set of carrier data of the plurality of access nodes; determine a classification of the plurality of access nodes based on types of the plurality of access nodes, the multiple data sets of the plurality of access nodes, and a logical map of the plurality of access nodes, wherein the logical map of the plurality of access nodes is determined based on at least locations of the plurality of access nodes; and determine an order of shutting down the plurality of access nodes based on the logical map and the classification of the plurality of access nodes.
16. The non-transitory, computer-readable storage medium of solution 15, wherein the instructions cause the system to: perform training based on historical data sets of the plurality of access nodes.
17. The non-transitory, computer-readable storage medium of solution 15, wherein the types of the plurality of access nodes comprise at least a macro cell type or micro cell type.
18. The non-transitory, computer-readable storage medium of solution 15, wherein the first set of power data comprises power consumption data of the plurality of access nodes, wherein the second set of utilization data comprises at least one of: a central processing unit utilization rate of each access node or a time-frequency resource utilization rate of each access node, and wherein the third set of carrier data comprises at least usage information for component carriers, usage information for connection types, or usage information for service types.
19. The non-transitory, computer-readable storage medium of solution 15, wherein the order indicates a partial shutdown of selected carriers of an access node based on the third set of carrier data.
20. The non-transitory, computer-readable storage medium of solution 15, wherein the order is determined iteratively until a power consumption target for the plurality of access nodes is achieved.

Example solutions related to shutdown of core network nodes are described below.
21. A method for wireless communication, comprising: receiving, by a network node in a core network, information about a plurality of core network nodes indicating locations of the plurality of core network nodes and types of the plurality of core network nodes, wherein the information indicates at least a redundant deployment of at least one core network node; monitoring multiple data sets of the plurality of core network nodes, wherein the multiple data sets comprise a first set of power data of the plurality of core network nodes, a second set of utilization data of the plurality of core network nodes, and a third set of connection data of the plurality of core network nodes; establishing a logical map of the plurality of core network nodes based on at least the information and the third set of connection data of the plurality of core network nodes using one or more machine learning models, wherein the one or more machine learning models are trained based on historical data sets of the plurality of core network nodes; determining a classification of the plurality of core network nodes based on the multiple data sets of the plurality of core network nodes and the logical map of the plurality of core network nodes using the one or more machine learning models; and determining an order of shutting down the plurality of core network nodes based on the logical map and the classification of the plurality of core network nodes.
22. The method of solution 21, wherein the types of the plurality of core network nodes comprise at least one of an Access and Mobility Management Function (AMF) type, a Unified Data Management (UDM) type, a Session Management Function (SMF) type, or a Network Function Repository Function (NRF) type.
23. The method of solution 21, wherein the first set of power data comprises power consumption data of the plurality of core network nodes, and wherein the second set of utilization data comprises at least one of: a central processing unit utilization rate of each core network node or a bandwidth utilization rate of each core network node.
24. The method of solution 21, wherein the third set of connection data comprises at least information about data packets in radio data bearers or network sessions.
25. The method of solution 21, wherein the classification comprises grouping of the plurality of core network nodes into primary nodes and backup nodes.
26. The method of solution 25, wherein the logical map includes information indicating the primary nodes and the backup nodes.
27. The method of solution 21, wherein the order is determined iteratively until a power consumption target for the plurality of core network nodes is achieved.
28. A device for wireless communication in communication with one or more machine learning models, the device comprising at least one processor that is configured to cause the device to: receive information about a plurality of core network nodes indicating locations of the plurality of core network nodes and types of the plurality of core network nodes, wherein the information indicates at least a redundant deployment of at least one core network node; monitor multiple data sets of the plurality of core network nodes, wherein the multiple data sets comprise a first set of power data of the plurality of core network nodes, a second set of utilization data of the plurality of core network nodes, and a third set of connection data of the plurality of core network nodes; establish a logical map of the plurality of core network nodes based on at least the information and the third set of connection data of the plurality of core network nodes using the one or more machine learning models, wherein the one or more machine learning models are trained based on historical data sets of the plurality of core network nodes; determine a classification of the plurality of core network nodes based on the multiple data sets of the plurality of core network nodes and the logical map of the plurality of core network nodes using the one or more machine learning models; and determine an order of shutting down the plurality of core network nodes based on the logical map and the classification of the plurality of core network nodes.
29. The device of solution 28, wherein the types of the plurality of core network nodes comprise at least one of an Access and Mobility Management Function (AMF) type, a Unified Data Management (UDM) type, a Session Management Function (SMF) type, or a Network Function Repository Function (NRF) type.
30. The device of solution 28, wherein the first set of power data comprises power consumption data of the plurality of core network nodes, and wherein the second set of utilization data comprises at least one of: a central processing unit utilization rate of each core network node or a bandwidth utilization rate of each core network node.
31. The device of solution 28, wherein the third set of connection data comprises at least information about data packets in radio data bearers or network sessions.
32. The device of solution 28, wherein the classification comprises grouping of the plurality of core network nodes into primary nodes and backup nodes.
33. The device of solution 32, wherein the logical map includes information indicating the primary nodes and the backup nodes.
34. The device of solution 28, wherein the order is determined iteratively until a power consumption target for the plurality of core network nodes is achieved.
35. A non-transitory, computer-readable storage medium comprising instructions recorded thereon, wherein the instructions, when executed by at least one data processor of a system, cause the system to: receive multiple data sets associated with a plurality of core network nodes, wherein the multiple data sets comprise a first set of power data of the plurality of core network nodes, a second set of utilization data of the plurality of core network nodes, and a third set of connection data of the plurality of core network nodes; establish a logical map of the plurality of core network nodes based on at least (1) information about the plurality of core network nodes indicating locations of the plurality of core network nodes and types of the plurality of core network nodes and (2) the third set of connection data of the plurality of core network nodes, wherein the information indicates at least a redundant deployment of at least one core network node; determine a classification of the plurality of core network nodes based on the multiple data sets of the plurality of core network nodes and the logical map of the plurality of core network nodes; and determine an order of shutting down the plurality of core network nodes based on the logical map and the classification of the plurality of core network nodes.
36. The non-transitory, computer-readable storage medium of solution 35, wherein the instructions cause the system to: perform training based on historical data sets of the plurality of core network nodes.
37. The non-transitory, computer-readable storage medium of solution 35, wherein the types of the plurality of core network nodes comprise at least one of an Access and Mobility Management Function (AMF) type, a Unified Data Management (UDM) type, a Session Management Function (SMF) type, or a Network Function Repository Function (NRF) type.
38. The non-transitory, computer-readable storage medium of solution 35, wherein the first set of power data comprises power consumption data of the plurality of core network nodes, and wherein the second set of utilization data comprises at least one of: a central processing unit utilization rate of each core network node or a bandwidth utilization rate of each core network node.
39. The non-transitory, computer-readable storage medium of solution 35, wherein the classification comprises grouping of the plurality of core network nodes into primary nodes and backup nodes, and wherein the logical map includes information indicating the primary nodes and the backup nodes.
40. The non-transitory, computer-readable storage medium of solution 35, wherein the order is determined iteratively until a power consumption target for the plurality of core network nodes is achieved.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for wireless communication, comprising:
receiving, by a network node in a core network, information about a plurality of access nodes indicating locations of the plurality of access nodes and types of the plurality of access nodes;
monitoring, by the network node, multiple data sets of the plurality of access nodes,
wherein the multiple data sets comprise a first set of power data of the plurality of access nodes, a second set of utilization data of the plurality of access nodes, and a third set of carrier data of the plurality of access nodes;
establishing, by the network node, a logical map of the plurality of access nodes based on at last the locations of the plurality of access nodes;
determining, by the network node, a classification of the plurality of access nodes based on the types of the plurality of access nodes, the multiple data sets of the plurality of access nodes, and the logical map of the plurality of access nodes using one or more machine learning models,
wherein the one or more machine learning models are trained based on historical data sets of the plurality of access nodes; and
determining, by the network node, an order of shutting down the plurality of access nodes based on the logical map and the classification of the plurality of access nodes using the one or more machine learning models.

2. The method of claim 1, wherein the types of the plurality of access nodes comprise at least a macro cell type or micro cell type.

3. The method of claim 1, wherein the first set of power data comprises power consumption data of the plurality of access nodes, and wherein the second set of utilization data comprises at least one of: a central processing unit utilization rate of each access node or a time-frequency resource utilization rate of each access node.

4. The method of claim 1, wherein the third set of carrier data comprises at least usage information for component carriers, usage information for connection types, or usage information for service types.

5. The method of claim 1, wherein the classification comprises grouping of the plurality of access nodes based on the first set of power data and the second set of utilization data.

6. The method of claim 1, wherein the order indicates a partial shutdown of selected carriers of an access node based on the third set of carrier data.

7. The method of claim 1, wherein the order is determined iteratively until a power consumption target for the plurality of access nodes is achieved.

8. A device for wireless communication in communication with one or more machine learning models, the device comprising at least one processor that is configured to cause the device to:
receive information about a plurality of access nodes indicating locations of the plurality of access nodes and types of the plurality of access nodes;
monitor multiple data sets of the plurality of access nodes,
wherein the multiple data sets comprise a first set of power data of the plurality of access nodes, a second set of utilization data of the plurality of access nodes, and a third set of carrier data of the plurality of access nodes;
establish a logical map of the plurality of access nodes based at least on the locations of the plurality of access nodes;
determine a classification of the plurality of access nodes based on the multiple data sets of the plurality of access nodes and the logical map of the plurality of access nodes using the one or more machine learning models,
wherein the one or more machine learning models are trained based on historical data sets of the plurality of access nodes; and
determine an order of shutting down the plurality of access nodes based on the logical map and the classification of the plurality of access nodes using the one or more machine learning models.

9. The device of claim 8, wherein the types of the plurality of access nodes comprise at least a macro cell type or micro cell type.

10. The device of claim 8, wherein the first set of power data comprises power consumption data of the plurality of access nodes, and wherein the second set of utilization data comprises at least one of: a central processing unit utilization rate of each access node or a time-frequency resource utilization rate of each access node.

11. The device of claim 8, wherein the third set of carrier data comprises at least usage information for component carriers, usage information for connection types, or usage information for service types.

12. The device of claim 8, wherein the classification comprises grouping of the plurality of access nodes based on the first set of power data and the second set of utilization data.

13. The device of claim 8, wherein the order indicates a partial shutdown of selected carriers of an access node based on the third set of carrier data.

14. The device of claim 8, wherein the order is determined iteratively until a power consumption target for the plurality of access nodes is achieved.

15. A non-transitory, computer-readable storage medium comprising instructions recorded thereon, wherein the instructions, when executed by at least one data processor of a system, cause the system to:
receive multiple data sets associated with a plurality of access nodes,
wherein the multiple data sets comprise a first set of power data of the plurality of access nodes, a second set of utilization data of the plurality of access nodes, and a third set of carrier data of the plurality of access nodes;
determine a classification of the plurality of access nodes based on types of the plurality of access nodes, the multiple data sets of the plurality of access nodes, and a logical map of the plurality of access nodes,
wherein the logical map of the plurality of access nodes is determined based on at least locations of the plurality of access nodes; and
determine an order of shutting down the plurality of access nodes based on the logical map and the classification of the plurality of access nodes.

16. The non-transitory, computer-readable storage medium of claim 15, wherein the instructions cause the system to:
perform training based on historical data sets of the plurality of access nodes.

17. The non-transitory, computer-readable storage medium of claim 15, wherein the types of the plurality of access nodes comprise at least a macro cell type or micro cell type.

18. The non-transitory, computer-readable storage medium of claim 15, wherein the first set of power data comprises power consumption data of the plurality of access nodes, wherein the second set of utilization data comprises at least one of: a central processing unit utilization rate of each access node or a time-frequency resource utilization rate of each access node, and wherein the third set of carrier data comprises at least usage information for component carriers, usage information for connection types, or usage information for service types.

19. The non-transitory, computer-readable storage medium of claim 15, wherein the order indicates a partial shutdown of selected carriers of an access node based on the third set of carrier data.

20. The non-transitory, computer-readable storage medium of claim 15, wherein the order is determined iteratively until a power consumption target for the plurality of access nodes is achieved.
